(19) United States
(12) Patent Application Publication
(10) Pub. No.: US 2021/0012435 A1
(43) Pub. Date: Jan. 14, 2021

(54) TRANSACTIVE ENERGY SYSTEM AND METHOD

(71) Applicant: Aclara Technologies LLC, St. Louis, MO (US)

(72) Inventor: David Haynes, St. Peters, MO (US)

(21) Appl. No.: 16/923,542

(22) Filed: Jul. 8, 2020

Related U.S. Application Data
(60) Provisional application No. 62/871,288, filed on Jul. 8, 2019.

(51) Int. Cl. G06Q 50/06; G06Q 20/14; G05B 19/042

(52) U.S. Cl. CPC G06Q 50/06; G05B 2219/2639; G05B 19/042; G06Q 20/14

(57) ABSTRACT

Systems and methods for performing energy transactions including a number of market participant nodes associated with an energy market participant, and a number of market authority node devices associated with a market authority. A network operator node device is further included, which is associated with a network operator. The market participant node device, the market authority node devices, and the network operator node devices are configured to communicate with each other to facilitate an energy transaction.

### CROSS-REFERENCE TO RELATED APPLICATIONS

This application claims priority to U.S. Provisional Patent Application No. 62/871,288, filed Jul. 8, 2019, the contents of which are hereby incorporated by reference in their entirety.

### BACKGROUND

Electrical distribution systems are generally built to accommodate centralized generation and distribution of electrical energy. However, today's wholesale market generally does not have the requisite capability to address issues within the distribution system that are downstream of a substation with a distribution network (e.g. “grid”). For example, large scale distributed electrical generation resulting, for example, from rooftop solar panels or the like which require changes to today's current system of electrical distribution. Accordingly, systems and methods for transactive energy systems are important to address these changes to modern day electrical distribution.

### SUMMARY

According to one example, a system for performing energy transactions is described. The system includes a number of market participant node devices, wherein each market participant node device is associated. The system also includes a number of market authority node devices, wherein each market authority node devices is associated with a market authority. The system also includes one or more network operator node devices, wherein each market authority node device is associated with a network operator. The market participant node devices, the market authority node devices, and the network operator node devices are configured to communicate with each other to facilitate an energy transaction.

In one aspect of the system, one or more of the market participant node devices, the market authority node devices, and the network operator devices are configured to generate one or more software agents configured to facilitate the energy transaction.

In one aspect of the system, the one or more software agents include an energy buyer software agent, an energy seller software agent, and an infrastructure owner agent.

In one aspect of the system, the energy buyer software agent generates a request to buy electric power.

In one aspect of the system, the energy seller software agent and the infrastructure owner agent process the generated request, wherein processing the generated request includes determining a price based on one or more of power generation capacity, power price, infrastructure capacity, and infrastructure cost.

In one aspect of the system, the generated software agents are associated with a local energy market pool node device.

In one aspect of the system, the local energy market pool node device generates a local energy market pool software agent that includes information associated with one or more market participant transaction requests within a service area of the local energy market pool node. The local energy market pool node transmits the local energy market pool software agent to a regional energy market pool node having a service area that is larger than, and includes, the local energy market pool node.

In one aspect of the system, one or more market authority nodes are configured to determine the viability of a proposed transaction.

In one aspect of the system, one or more network operator nodes are configured to facilitate the execution of an approved transaction.

In one aspect of the system, each of the node devices includes an electronic processor, a memory, and a communication interface configured to facilitate communication with one or more other node devices.

In one aspect of the system, each of the market participant node devises are configured to be integrated in, or in proximity to, a device associated with the market participant.

In one example, a method for facilitating an energy transaction using a number of electronic node devices is described. The method includes requesting a bid for a quantity of electrical power via a buyer electronic node device associated with a buyer of electrical power, and determining a viability of the bid by an engineering analysis authority electronic node device. In response to the bid being determined to be viable, negotiating a bid price at one or more network pool node devices. One or more software agents associated with the one or more network pool device are configured to negotiate the bid price based on a plurality of market conditions, approve the negotiated bid price at the buyer electronic node device, and provide the power to the buyer of electrical power in response to the negotiated bid price being approved by the buyer electronic node device.

In one aspect of the method, a network operator electronic node device is configured to remotely control a generator associated with an energy seller to facilitate providing power to the buyer of the electrical power.

In one aspect of the method, each of the node devices includes an electronic processor, a memory, and a communication interface configured to facilitate communication with one or more other node devices.

In one aspect of the method, the one or more network pool node devices include a local pool node device, a regional pool node device, and a national pool node device.

In one aspect, the method further including generating, at the local pool node device, a local energy market pool software agent including information associated with one or more market participant transaction requests within a service area of the local energy market pool node. The method also includes transmitting, by the local pool node device, a regional market pool software agent comprising information associated with one or more local energy market pool software agents, and generating, at the regional pool node device, a regional market pool software agent comprising information associated with one or more local energy market pool software agents.

In one aspect, the method also includes transmitting, by the regional pool node device, the regional energy market pool software agent to the national pool node device. The method also includes determining a wholesale price for energy based on information provided by one or more regional energy market pool software agents, and transmitting, by the national pool node device, the whole sale price to one or more of the regional node device and the local node device.

In one example a system for performing energy transactions is described. The system includes a number of market participant node device, wherein each market participant node device is associated with an energy market participant and configured to generate one or more energy market participant software agents to facilitate an electrical power transaction. The system also includes a number of market authority node devices, wherein each market authority node device is associated with a market authority. Each market authority node device is associated with an energy market authority and configured to generate one or more energy market authority software agents to facilitate the electrical power transaction. The system also includes one or more network operator nodes devices, wherein each market authority node device is associated with a network operator and configured to generate one or more network operator software agents to facilitate the electrical power transaction. The market participant node devices, the market authority devices, and the network operator node devise are configured to communicate with each other to facilitate a proposed energy transaction. The one or more market authority software agents are configured to determine the viability of the proposed energy transaction.

In one aspect of the system, the one or more market participant software agents include an energy buyer software agent, an energy seller software agent, and an infrastructure owner agent.

In one aspect of the system, the energy buyer software agent generates a request to buy electric power. The energy seller software agent and the infrastructure owner agent process the generated request, wherein processing the generated request comprises determining a price based on one or more of power generation capacity, power prices, infrastructure capacity, and infrastructure costs.

Other aspects of the technology will become apparent by consideration of the detailed description and accompanying drawings.

### BRIEF DESCRIPTION OF THE DRAWINGS

FIG. 1 is a block diagram representation of a transactive energy marketplace, according to an exemplary embodiment.

FIG. 2 is a block diagram illustrating multiple authorities for overseeing market operations, according to an exemplary embodiment.

FIG. 3 is a block diagram illustrating market interaction with network operations, according to an exemplary embodiment.

FIG. 4 is a block diagram illustrating a node device, according to an exemplary embodiment.

FIG. 5 is diagram illustrating how software agents work on behalf of market participants, according to an exemplary embodiment.

FIG. 6 is a flow chart illustrating a distributed computing used in a transactional energy marketplace, according to an exemplary embodiment.

FIG. 7 is a block diagram representing distributed communications within a transactional energy marketplace, according to an exemplary embodiment.

FIG. 8 is a diagram representing the scale of possible interactions in a transactional energy marketplace, according to an exemplary embodiment.

FIG. 9 is a diagram indicating processing requirements for various market participants in a transactional energy marketplace, according to an exemplary embodiment.

FIG. 10 is a diagram illustrating a market cycle within a transactional energy marketplace, according to an exemplary embodiment.

FIG. 11 illustrates an exemplary bidding process within a transactional energy marketplace, according to an exemplary embodiment.

FIG. 12 illustrates a capacity of tiers within a transactional energy marketplace, according to an exemplary embodiment.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

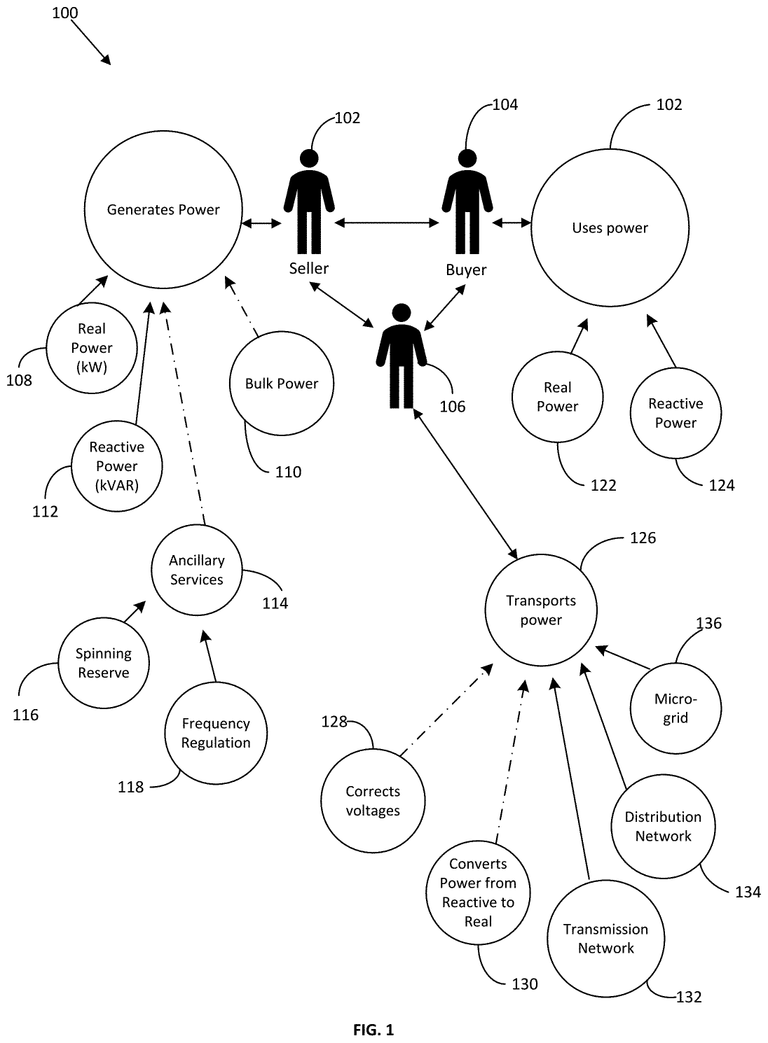

FIG. 1 is a block diagram of a transactive energy marketplace showing the three main market participants 100 within the marketplace 100. The three main market participants include a seller 102, a buyer 104, and an owner of the distribution infrastructure 106. Each of the participants may be responsible for services, products or usages. For example, the seller 102 is generally responsible for the generation of power. This can include real power (kW) 108, bulk power 110, reactive power (kVAR) 112, and other ancillary services 114, such as spinning reserve (e.g. reserve power generation capability), a frequency regulation.

The buyer 104 participant is generally responsible for the use of power 120, such as consuming real power 122 and reactive power 124. The real power 122 and reactive power 124 consumption may be monitored by one or more devices, such as electrical utility meters. The owner 106 is generally responsible for the transportation of power 126, which can include providing voltage correction 128, converting power from reactive power to real power 130, building, maintaining and updating a transmission network 132 (e.g. transmission lines), building, maintaining and updating distribution networks 134 (e.g. electrical substations, distribution power lines, transformers, etc.), and controlling or establishing micro-grids 136.

In the past, the above described participants may have been individuals, groups, or companies. However, in the embodiments described herein, the participants may be represent by one or more computing devices, or nodes, as will be described in more detail below. Further, in some embodiments, the participants may all reside near each other, such as within a single utility provider which owns both the generation and distribution (e.g. “wires”) in an area managed by the utility's network operators (discussed in more detail below), as well as in nearby areas which lack a wholesale energy market footprint. In other embodiments, the participants may reside at some distance from each other, e.g. across a country, being connected by transmission lines, and overseen by an independent systems operator (ISO) or regional transmission operator (RTO).

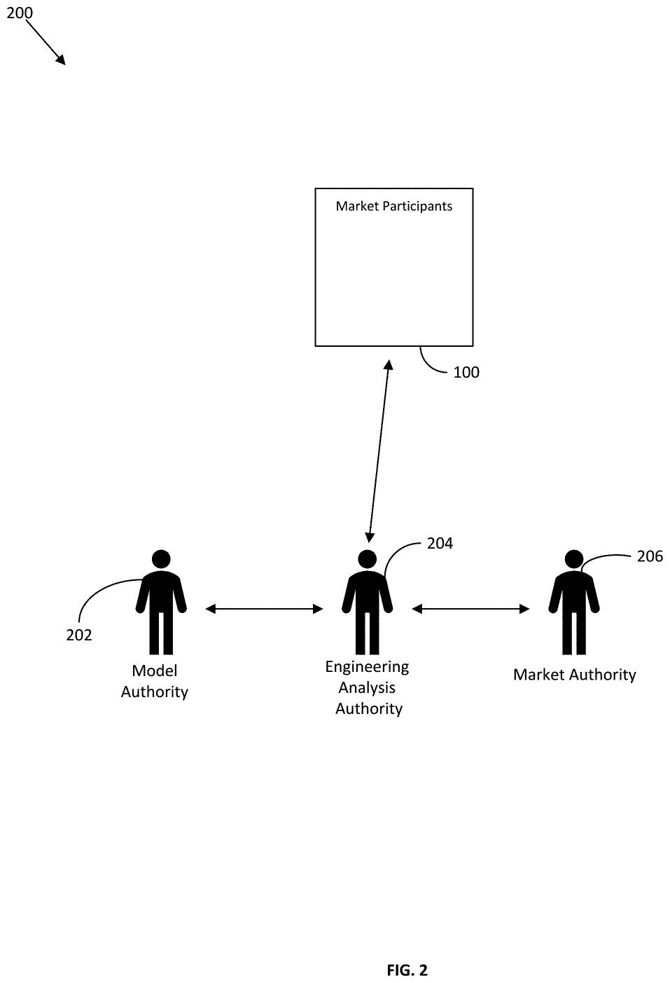

Turning now to FIG. 2, a block diagram illustrating a regulator system having multiple authorities 200, such as a model authority 202, an engineer analysis authority 204, and a market authority 206. The authorities interact with the various market participants to ensure fair, viable outcomes when negotiating utilities by the market participants 100. In one example, the model authority maintains 202 official records of connectivity (e.g. transmission line capability, interconnections between distribution equipment and providers, etc.), as well as asset ratings. The engineering analysis authority 204 considers viability of proposed power transmission from a design perspective, and ensures sufficient levels of ancillary services (e.g. spin reserve) have been or will be purchased as part of the negotiations. Finally, the market authority oversees the marketplace and maintains official records of executed contracts for the purchase and sale of electrical power. The market authority 206 is further responsible for facilitating the sale of aggregated loading or power generation on the market.

Similar to the market participants 100, the above described authorities 200 may have been individuals, groups, or companies. However, in the embodiments described herein, the authorities 200 may be represent by one or more computing devices, or nodes, as will be described in more detail below. Further, in some embodiments, the authorities may all be responsible for a specific region, or for a large portion, or entirety, of a country.

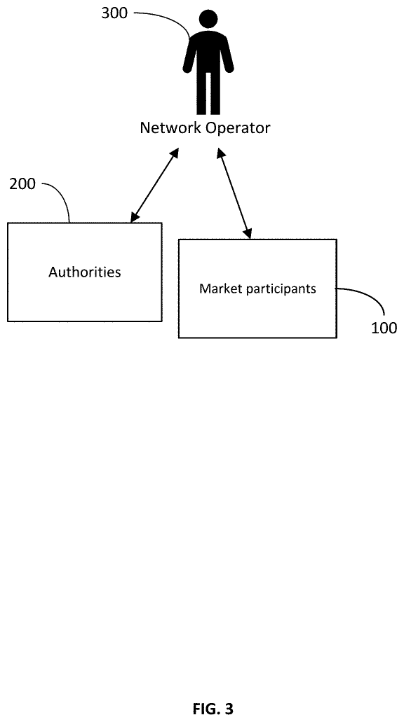

Turning now to FIG. 3, a diagram illustrating a network operator 300 in communication with various authorities 200 and market participants 100. Network operators 300 generally interface with local owners of distribution (wire) assets to ensure the proper transmission and delivery of power across a network. As will be described in more detail below, network operators 300 are configured to perform various actions such as adjusting voltages and/or other parameters of a distribution network to manage a flow of power in “real” time. In some embodiments, the network operator 300 is the only stakeholder who can identify a system-wide load imbalance and adjusting spinning reserves accordingly. Furthermore, the network operator 300 may be able to manage all power generators, such as typical power generation systems (fossil fuel, nuclear, hydro) as well as renewable power when evaluating and requesting power from spinning reserves, which can further include direct load control (DLC) systems and other forms of demand response (DR).

The network operator is responsible for monitoring transmission networks (e.g. voltage levels, power transmission, etc.), and issuing requests for demand reduction. For example, where the demand exceeds an available supply (or is approaching the supply level), the network operator may issue requests for a reduction in demand to avoid brownout conditions or overloads to the distribution network. The network operator 300 may also be configured to issue commands to the infrastructure, such as via the owner 106, to adjust voltages and currents of power in a distribution network. The network operator 300 may also communicate with the market participants 100 to request spinning reserves be dispatched, such as to increase capacity of the distribution network. The network operator 300 may further communicate with local owners of wires (power lines) to adjust voltages and/or VARs. The network operator 300 may further receive information about spinning reserves via the authorities 200.

Similar to above, the above described participants may have been individuals, groups, or companies in the past. However, in the embodiments described herein, the network operators 300 may, in whole or in part, be represent by one or more computing devices, or nodes, as will be described in more detail below. Further, in some embodiments, the network operators 300 may be responsible for a local distribution network, a regional distribution network, or a large scale utility transmission network.

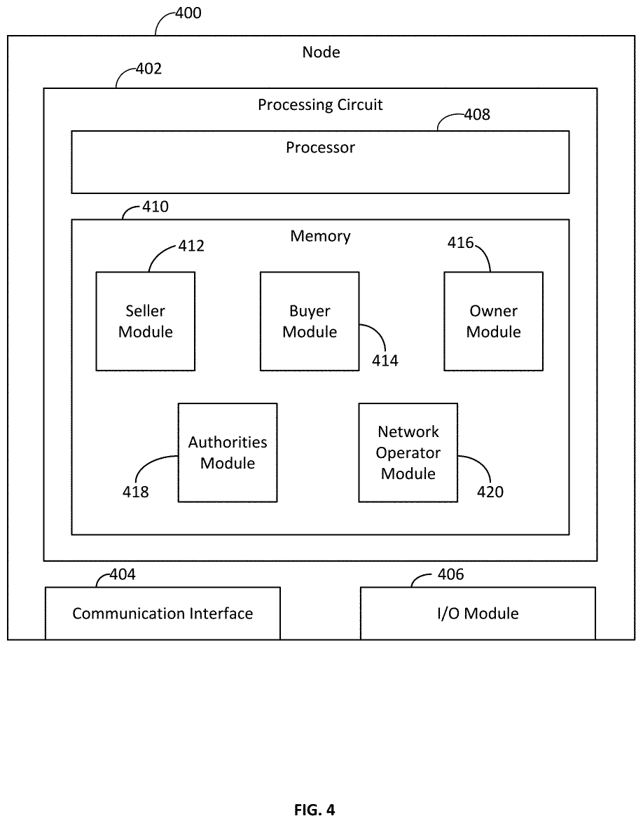

Turning now to FIG. 4, a block diagram illustrating a node device 400 is shown, according to some embodiments. As described above, the node 400 may be configured to represent one or more of the market participants 100, the authorities 200, and/or the network operator 300. Accordingly, multiple nodes 400 may be distributed within a given area, network, region, etc. to facilitate the purchase, consumption, selling, and regulation of power within a given network. The nodes 400 are configured to represent the interest of some or all of the associated stakeholders (e.g. market participants 100, authorities 200, network operators 300) to automatically broker an agreement on their behalf.

The node 400 includes a processing circuit 402, a communication interface 404, and an input/output (I/O) interface 406. The processing circuit 402 includes an electronic processor 408 and a memory 410. The processing circuit 402 may be communicably connected to one or more of the communication interface 404 and the I/O interface 406. The electronic processor 408 may be implemented as a programmable microprocessor, an application specific integrated circuit (ASIC), one or more field programmable gate arrays (FPGA), a group of processing components, or with other suitable electronic processing components.

The memory 410 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory 410 may include database components, object code components, script components, or other types of code and information for supporting the various activities and information structure described in the present application. According to one example, the memory 410 is communicably connected to the electronic processor 408 via the processing circuit 402 and may include computer code for executing (for example, by the processing circuit 402 and/or the electronic processor 408) one or more processes described herein.

The communication interface 404 is configured to facilitate communication between the node 400 and one or more external devices or systems, such as other nodes. The communication interface 404 may be, or include, wireless communication interfaces (for example, antennas, transmitters, receivers, transceivers, etc.) for conducting data communications between the node 400 and one or more external devices, such as other nodes or systems. In some embodiments, the communication interface 404 utilizes a proprietary protocol for communicating with other devices. For example, the proprietary protocol may be an RF-based protocol configured to provide efficient and effective communication between the node 400 and other devices. In other embodiments, other wireless communication protocols may also be used, such as cellular (3G, 4G, 5G, LTE, CDMA, etc.), Wi-Fi, LoRa, LoRaWAN, Z-wave, Thread, and/or any other applicable wireless communication protocol.

The I/O module 406 may be configured to interface directly with one or more devices, such as a power supply, a power monitor, etc. In one embodiment, the I/O module 406 may utilize general purpose I/O (GPIO) ports, analog inputs, digital inputs, etc. In one embodiment, the I/O module 406 allows for the node device 400 to interface with one or more other devices associated with a particular node device. For example, metering devices, substations, thermostats, transformers, switchgear, and the like.

As described above, the memory 410 may be configured to store various processes, layers, and modules, which may be executed by the electronic processor 408 and/or the processing circuit 202. For example, the memory 410 may include one or more of a seller module 412, a buyer module 414, an owner module 416, an authorities module 418, and a network operator module 420. Each of the modules 412, 414, 416, 418, 420 are configured to perform operations associated with one or more of the market participants 100, the authorities 200, and/or the network operators 300, as will be described in more detail below. In some embodiments, the authorities module 418 is one or more of a model authority module, an engineering analysis authority module, and a market authority module.

In addition, each of the above modules 412, 414, 416, 418, 420 may include one or more software agents or bots that are configured to execute one or more operations of the associated module. In some examples, the modules 412, 414, 416, 418, 420 are configured to generate agents in regards to a specific request, such as for each transaction. In other examples, agents may be generated to handle multiple requests or operations. Accordingly, some agents may be deleted or modified at the completion of a specific, discrete task, such as a transaction. Once a deal or contract is obtained, the agent may no longer be needed. In other examples, the agent may be configured to ensure that the contract is fulfilled. However, in other embodiments, new agents may be generated by the respective modules 412, 414, 416, 418, 420 to ensure that a contract or deal is fulfilled.

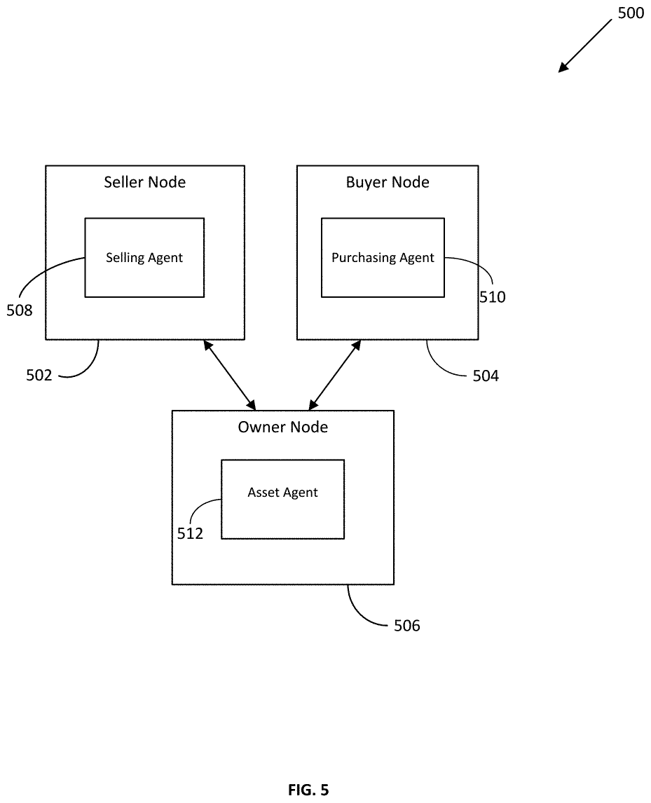

FIG. 5 illustrates an example bidding process 500 using various agents, as described above. A seller node 502, a buyer node 504, and an owner node 506 may be in communication with each other to facilitate a transaction. The seller node 502, buyer node 504, and owner node 506 bay be similar to the nodes 400 described above. The seller node 502 may include a selling agent 508 that is generated to facilitate the bidding process 500. The selling agent 508 may be configured to access one or more other devices, such as internet-based servers, other nodes, seller databases, etc. to acquire various information required to determine what is available to the seller, as well as what would be the required cost based on request amount, current pricing, etc. For example, the selling agent 508 may access one or more power generation forecasts to determine what availability the seller has, which can be used by the seller agent 508 to determine a desired price.

Similar a buyer node 504 may include a purchasing agent 510 that is generated to facilitate the bidding process 500. The purchasing agent 510 may be configured to access one or more other devices, such as internet-based servers, other nodes, purchaser databases, etc. to acquire information required to determine what is needed by the purchaser, as well as desired costs, etc. For example, the purchasing agent 510 may access one or more load forecasts to determine a load estimated to be required by a network over a period of time, which can be used by the purchasing agent 510 to determine a desired amount of power needed, as well as a suggested price.

Finally, an owner node 506 may include an asset agent 512 that is generated to facilitate the bidding process 500. The asset agent 512 may be configured to access one or more other devices, such as internet-based servers, other nodes, owner databases, etc. to acquire information required to determine what is needed by the purchaser, as well as desired costs, etc. For example, the owner node 506 may access one or more system models to determine whether the infrastructure can handle the request, which can be used by the asset agent 512 to determine a cost associated with providing the requested power to the buyer, as well as other information associated with the requested transaction.

The selling agent 508, the purchasing agent 510, and the asset agent 512 may then work together to process the requested transaction and determine an acceptable contract for all parties, which may then automatically be agreed to by the respective agents, as described in more detail below. In other embodiments, the agents 508, 510, 512 may present the contract to their associated parties (e.g. sellers, purchasers, and buyers) for approval.

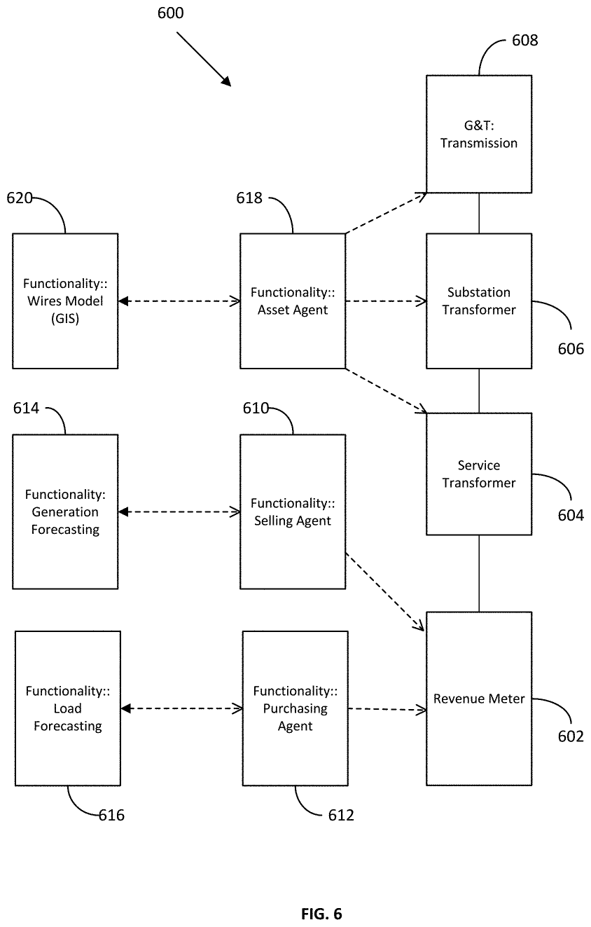

Turning now to FIG. 6, a diagram illustrating a system 600 for utilizing software agents to facilitate various transactions is shown, according to some embodiments. The system 600 may utilize various nodes at various places in a distribution network. For example, the system 600 may include a revenue meter node 602, a service transformer node 604, a substation transformer node 606, and a transmission node 608. The nodes 602, 604, 606, 608 may be similar to node 400 described above. The revenue meter node 602 may be associated with a residential (single or multi-family) facility, a commercial facility, and/or an industrial facility. In some examples, the revenue meter node 602 may be configured to purchase or bid for electricity for the facility it is associated with. In other embodiments, the revenue meter may be configured to provide data to one or more other nodes and/or software agents to generate one or more models, such as load forecasting models and/or generation forecasting models. These may be used as a baseline to set an amount of energy to be purchased at a rate schedule specified by a homeowner or facility operation.

In one example, and as will be discussed in more detail below, the revenue meter node 602 may be in communication with multiple other revenue meter nodes across a distribution network. In some embodiments, the revenue meter node 602 may communicate with other revenue meter nodes in a peer-to-peer communication topology via a network architecture, such as the internet or a closed network. However, even if the revenue meter node 602 determines, via communication between other revenue nodes, that power is available for purchase, the infrastructure must be available as well, requiring the revenue meter node 602 to further communicate with one or more nodes associated with the owner, such as via the service transformer node 604, the substation transformer node 606 and/or the transmission node 608. For example, the revenue meter node 602 may determine that another facility has power available but would still need to verify that the infrastructure is capable of facilitating the transaction.

As shown in FIG. 6, the revenue meter node provides information to, and receives information from, a selling agent 610 and/or a purchasing agent 612. The selling agent 610 and the purchasing agent 612 may be similar to the software agents described above. In one example, one or more of the selling agent 610 and/or the purchasing agent 612 reside on the revenue meter node 602. However, in other examples, one or more of the selling agent 610 and/or the purchasing agent 612 may reside on another node within the distribution network. The selling agent 610 may be configured to use information from one or more revenue meters 602 to generate a power generation forecasting model 614. The generation forecasting model 614 may be used by the selling agent to determine pricing when negotiating with the revenue meter node 602 (or other nodes within the distribution network). Similarly, the purchasing agent 612 may receive information from the revenue meter node 602 to determine a load forecasting model 616. The load forecasting model 616 may provide the information necessary for the purchasing agent to determine a cost (or range of costs) for the power revenue meter node 602.

The revenue meter node 602 may further be in communication with one or more of the service transformer node 604, the substation transformer node 606, and/or the transmission node 608. As described above, the service transformer node 604, the substation transformer node 606, and/or the transmission node 608 may be configured to provide infrastructure information to the revenue meter 602. In some embodiments, the infrastructure information may include cost associated with receiving power over the infrastructure, which can be used to facilitate a requested transaction.

The service transformer node 604, the substation transformer node 606, and/or the transmission node 608 may be in communication with one or more asset agents 618. The asset agents 618 may provide information, such as a wires model 620 to the service transformer node 604, the substation transformer node 606, and/or the transmission node 608 for determining an infrastructure available for a given requested transaction. The asset agent 618 may further generate cost or other information for a desired transaction, which can then be forwarded to the revenue meter node 602 (or other applicable nodes). In some embodiment, one or more generation nodes may use the information provided by the asset agent 618 to bid on various forms of generation and/or services. For examples, buyers and sellers of energy may be allowed to have programmed behavior within a market window so they can start a negotiation with their set asking prices, and then adjust their pricing as the transaction is processed that is agreeable for all stakeholders.

In the above example, it is contemplated that the revenue meter node 602, the service transformer node 604, the substation transformer node 606, and the transmission node 608 are located in close proximity to the stakeholder or equipment they represent. For example, the revenue meter node 602 is likely located at the facility it represents. For an industrial or commercial facility, the revenue meter node 602 may be located at or near the revenue meter associated with the facility. In contrast, for a residential facility such as a single family home, the revenue meter node 602 may be located at a localized level, such as at or within a thermostat of a home. For example, a software agent associated with the revenue meter node 602 may interface with the thermostat to access history, scheduled usage, occupancy, etc. the determine expected loading. In some examples, the software agent may modify the operation of the heating and cooling system to reduce costs to an occupant, in response to the occupant authorizing automated cost control.

Similarly, the service transformer node 604 may be located in close proximity to an associated service transformer, the substation transformer node 606 may be located in close proximity to an associated substation transformer, and the transmission node 608 may be located in close proximity to a portion of the transmission system associated with the transmission node 608.

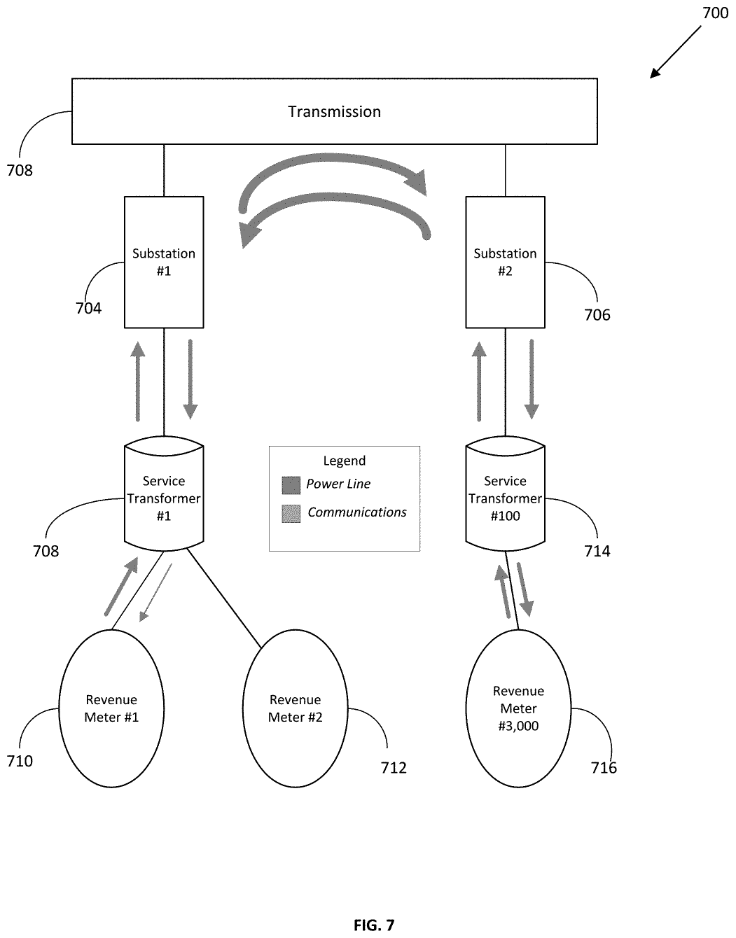

Turning now to FIG. 7, a hierarchical pool system 700 is shown, according to some embodiments. Due to the nature of energy transmission, it may not feasible or even desirable to allow for transactions to be determined between nodes across a large transmission area, such as across a country such as the United States. Partially, this is due to the limitations of the infrastructure, as well as natural issues such as transmission line loss. For example, even if lower cost power may be available across the country, the transmission losses may contribute to the cost to the extent that the “low cost” energy will cost more than locally purchased energy. Thus, many stakeholders (specifically buyers) are best served by finding a satisfactory supply at a satisfactory cost from a reasonably close power source.

The system 700 shows an example of this separation. A transmission network 700 is in communication with multiple substations 704, 706. Substation 704 may be a transmission substation for a given locality or region. Similarly, substation 706 may be a transmission substation for a different locality or region. Substation 704 is configured to provide power to one or more service transformers, such as service transformer 708. Service transformer 708 may further be in communication with a first revenue meter 710 and a second revenue meter 712. The first revenue meter 710 and the second revenue meter 712 may be similar to the revenue meters 712 described below, and may each include a revenue meter node as described herein. Further, the service transformer 708 may include a service transformer node, and substation 704 may include a substation node. In one example, the first revenue meter 710 and the second revenue meter 712 are configured to first try to form a transaction with the local utility system (e.g. the substation 704 and service transformer 708). This is to keep required communications down, as well as to provide the most efficient power to the first revenue meter 710 and/or the second revenue meter 712. Similarly, substation 706 provides power to service transformer 714, which then provides power to a third revenue meter 716. Third revenue meter 716 may be configured to be able to communicate with the first revenue meter 710 and the second revenue meter 712. While the revenue meters 710, 712, and 716 may be part of the same network, their locations may require, or benefit from, initiating transactions with their local utility, such as service transformer 714 and substation 706.

In addition to providing efficient and cost-effective power by first engaging local or regional power providers, by limiting the interaction between participants to a local or regional area first, the communication infrastructure can be more easily maintained as allowing for peer to peer communications for all participating devices (e.g. nodes) in a network may put a strain on both the communication infrastructure as well as computing ability for the distributed transactional system. For example, the first revenue meter 710 may wish to purchase electricity from a potential supplier at the third revenue meter 716, which may require a large number of interactions, such as 3000, facilitate. This can create a potential scalability problem, as with “N” participants, there are approximately N² interactions between just the first revenue meter 710 and the third revenue meter 716. Further taking into account the necessary infrastructure interactions, the number is (1.4N)².

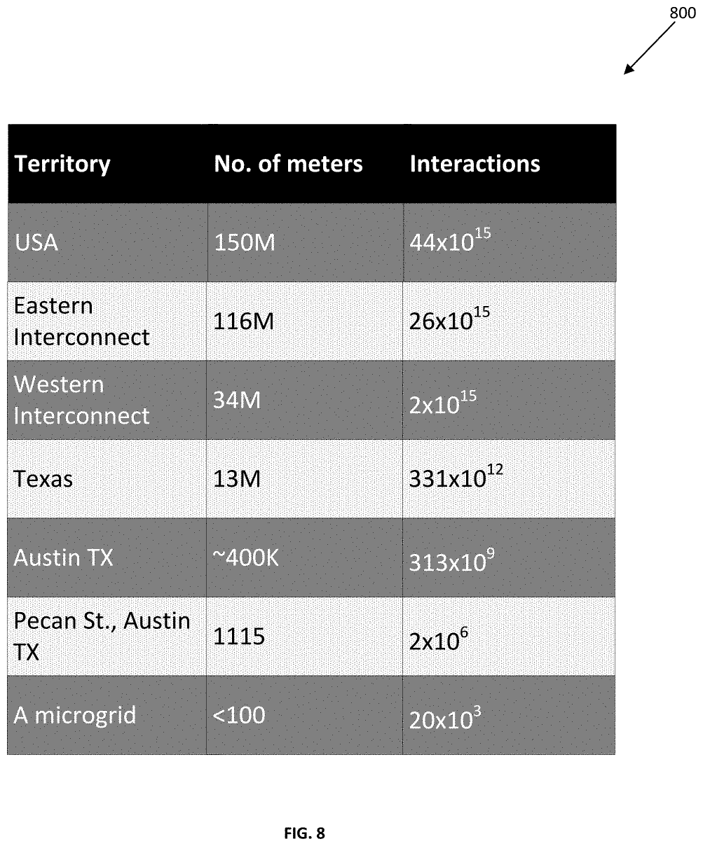

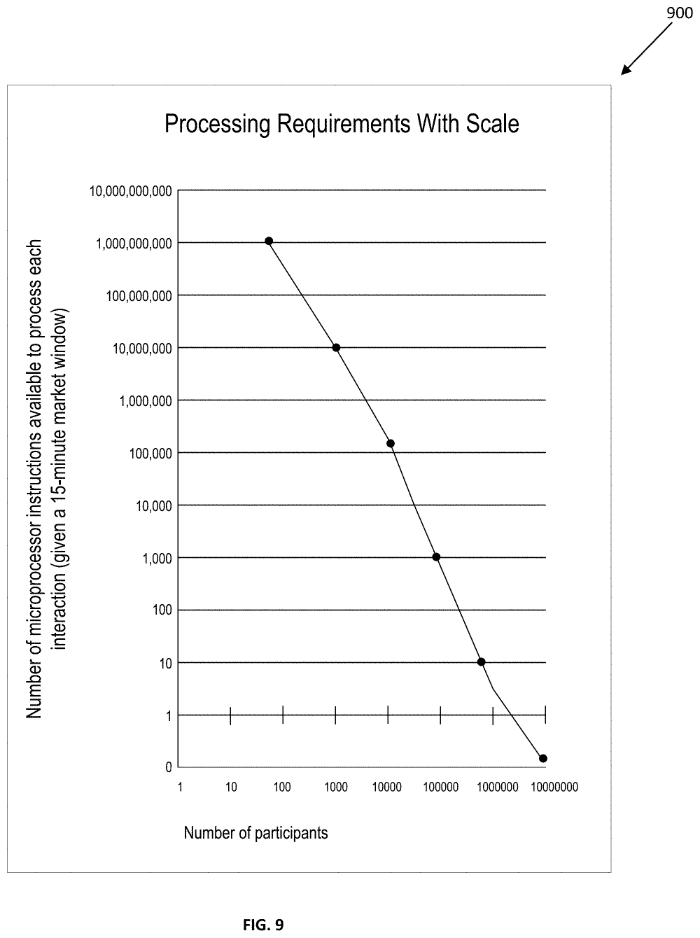

This can be seen in FIG. 8, which provides a chart 800 illustrates how the number of interactions is lowered substantially where the number of participants is reduced. FIG. 8 further illustrates these issues in regards to marketplace competition. As shown in FIG. 8, assuming that each participant (e.g. node, software agent, etc.) must be able to communicate with every other participant, and that each participant has its own microprocesses, and that there is a 15 minute market window in which to achieve the communication, then the worst case is that (1.4N)² messages are required to be processed by each participating node. This can further be seen in the graph 900 of FIG. 9, which illustrates the relationship between processing requirements and a number of participants. Thus, a properly established operating hierarchy allows the various software agents and associated nodes to represent the aggregate needs of the various pools (distribution networks) in markets at a higher level.

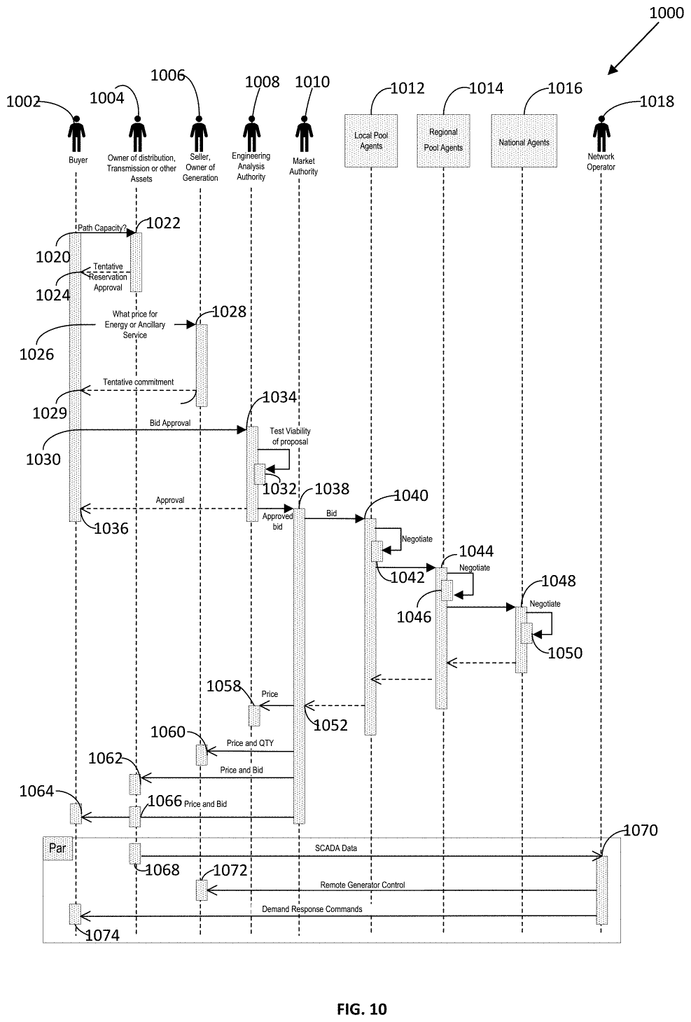

Turning now to FIG. 10 a process 1000 for executing a local market cycle negotiation between market participants and market authorities is shown according to some embodiments. The process may be conducted between the above participants, such a buyer 1002, an owner 1004, a seller 1006, an engineering analysis authority 1008, a market authority 1010, one or more local pool agents 1012, one or more district pool agents 1014, one or more interconnection agents 1016, and a network operator 1018. As described above, each of the above participants and authorities may be represented by a node, such as node 400 described above. Further, each node may have or generate one or more software agents to carry out the functions of process 1000, as described below. At process 1020, the buyer 1002 transmits a path capacity request to the owner 1004. The owner 1004 provides tentative capacity reservation approval at process 1022, which is received by the buyer 1002 at process bock 1026. The buyer 1002 then transmits a request for a price for energy or other ancillary services (e.g. spinning capacity, frequency regulation, etc.) to the seller 1006 at process block 1026. The seller 1006 generates a tentative commitment at a given price for the energy or ancillary service at process block 1028. The buyer 1002 receives the tentative commitment at process block 1029 and transmits a bid approval request to the engineering analysis authority 1008 at process block 1030. The engineering analysis authority 1008 conducts a viability test of the proposal at process block 1032, and generates an approval (based on the viability of the proposal) at process block 1034. The approved bid is then transmitted to the buyer 1002 at process block 1036.

The approved bid is then received by the market authority 1010 at process block 1038, which then transmits the bid to the one or more local pool agents 1012 at process block 1040. The local pool agents 1012 then negotiate the bid at process block 1042 and transmit the negotiated bid to the district pool agents 1014 at process block 1044. The district pool agents 1014 negotiate the bid at the district pool level at process block 1046 and transmit the negotiated bid to the interconnection agents 1016 at process block 1048. The interconnection agents 1016 negotiate the bid from an interconnection standpoint at process block 1050. The above negotiations between pool agents 1012, 1014, 1016 attempt to acquire an optimal price point in a larger market setting and/or a scaled transactive energy (TE) market. In one embodiment, the price is fixed at a wholesale level, and the set price is propagated to the local pool agents 1012 with a particular point on a curve fixed as a day-ahead price.

The finally negotiated bid is transmitted back to market authority 1010, as well as to the local pool agents 1012 and the district pool agents 1014 at process block 1052. The market authority 1010 then sends the price to the engineering analysis authority at process block 1058. The market authority 1010 sends the price to the seller 1006 at process block 1060. The price and bid are sent from the market authority 1010 to the owner 1004 and buyer 1002 at process block 1062 and 1064, respectively. Upon receiving price and bid, the buyer 1002 may approve the transaction at process block 1066, thereby creating a contract. In some embodiments, the approval is automatic based on the price being within a predetermined amount of the initial bid price.

The owner 1004 receives the approval at process block 1068 and provides the required data to the network operator 1018 to execute the contract. The network operation 1018 then transmits a remote generator control signal to the seller 1006 at process block 1072. The network operator further provides demand response commands to the buyer 1002 at process block 1074 to facilitate the supply of power.

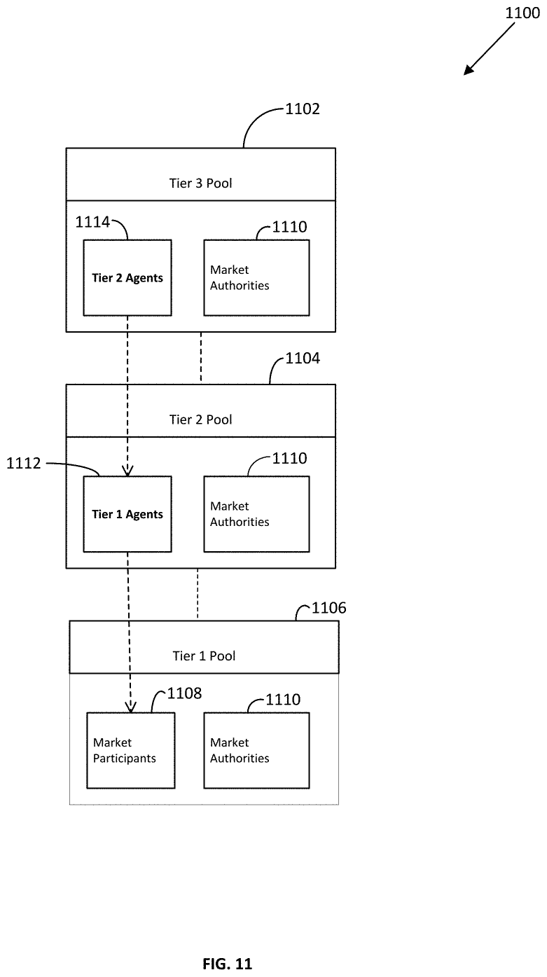

Turning now to FIG. 11, a block diagram illustrating a tiered hierarchy 1100 of pool agents, including a national pool agent 1102, a regional pool agent 1104, and a local pool agent 1106. The use of hierarchical pool agents allows for scalability issues to be addressed by allowing the pool agents to negotiate with the next pool within the hierarchy, removing the requirement of individual market participants to communicate with all other market participants.

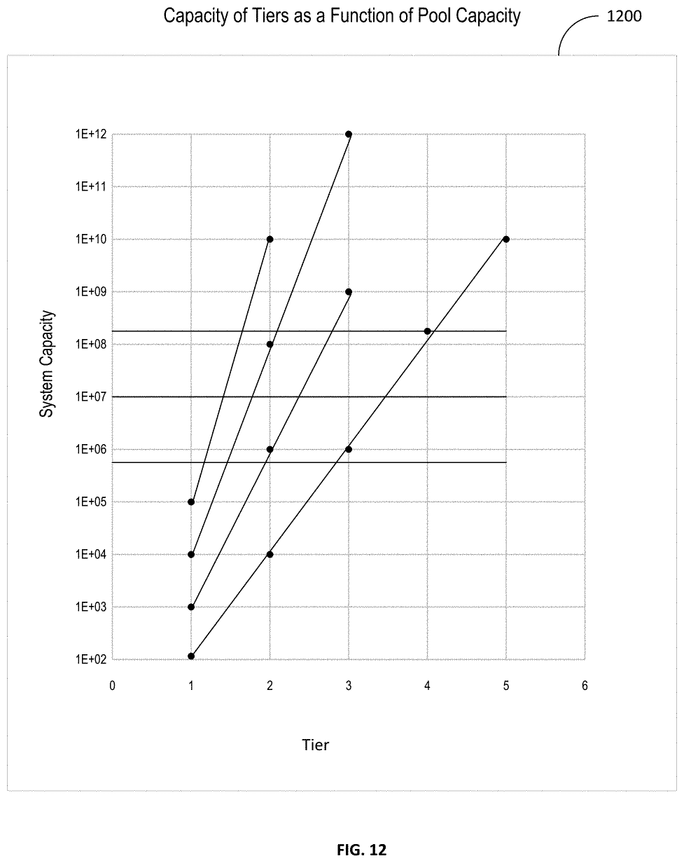

As shown in FIG. 11, the local pool 1106 may include information from one or more market participants 1108 and market authorities 1110. The market participants 1108 and market authorities 1110 may be similar to the market participants and market authorities described above. The local pool 1106 is configured to gather information from the one or more market participants and generate one or more local pool agents 1112 which are provided to the regional pool 1104. The regional pool 1104 may receive local pool agents 1112 from multiple local pools within an area covered by the regional pool 1104. The regional pool 1104 may then generate one or more regional pool agents 1114 based on the information provided to the regional pool 1004 via the local pool agents 1112. The regional pool agents 1114 may then be provided to the national pool 1102. The national pool 1102 may receive regional pool agents 1114 from multiple regional pools 1104. This tiered hierarchy 1100 can allow for transactions be determined on the national level without requiring peer to peer communication between all participants at all levels, thereby reducing the scalability issues associated therewith. This can be seen in FIG. 12, which shows the capacity of tiers as a function of pool capacity in the graph 1200.

What is claimed is:

1. A system for performing energy transactions, the system comprising:
a plurality of market participant node devices, wherein each market participant node device is associated with an energy market participant;
a plurality of market authority node devices, wherein each market authority node device is associated with a market authority;
one or more network operator node devices, wherein each market authority node device is associated with a network operator;
wherein the market participant node devices, the market authority node devices, and the network operator node devices are configured to communicate with each other to facilitate an energy transaction.

2. The system of claim 1, wherein one or more of the market participant node devices, the market authority node devices, and the network operator devices are configured to generate one or more software agents configured to facilitate the energy transaction.

3. The system of claim 2, wherein the one or more software agents include an energy buyer software agent, an energy seller software agent, and an infrastructure owner agent.

4. The system of claim 3, wherein the energy buyer software agent generates a request to buy electric power.

5. The system of claim 4, wherein the energy seller software agent and the infrastructure owner agent process the generated request, wherein processing the generated request comprises determining a price based on one or more of power generation capacity and infrastructure costs.

6. The system of claim 2, wherein the generated software agents are associated with a local energy market pool node device.

7. The system of claim 6, wherein the local energy market pool node device generates a local energy market pool software agent comprising information associated with one or more market participant transaction requests within a service area of the local energy market pool node; and
wherein the local energy market pool node transmits the local energy market pool software agent to a regional energy market pool node having a service area that is larger than, and includes, the local energy market pool node.

8. The system of claim 1, wherein the one or more market authority nodes are configured to determine the viability of a proposed transaction.

9. The system of claim 1, wherein the one or more network operator nodes are configured to facilitate the execution of an approved transaction.

10. The system of claim 1, wherein each of the node devices comprises an electronic processor, a memory, and a communication interface configured to facilitate communication with one or more other node devices.

11. The system of claim 1, wherein each of the market participant node devices are configured to be integrated in, or in proximity to, a device associated with the market participant.

12. A method for facilitating an energy transaction using a plurality of electronic node devices, the method comprising:
requesting a bid for a quantity of electrical power via a buyer electronic node device associated with a buyer of electrical power;
determining a viability of the bid by an engineering analysis authority electronic node device;
in response to the bid being determined to be viable, negotiating a bid price at one or more network pool node devices, wherein one or more software agents associated with the one or more network pool device are configured to negotiate the bid price based on a plurality of market conditions; approving the negotiated bid price at the buyer electronic node device; and
providing the power to the buyer of electrical power in response to the negotiated bid price being approved by the buyer electronic node device.

13. The method of claim 12, wherein a network operator electronic node device is configured to remotely control a generator associated with an energy seller to facilitate providing power to the buyer of the electrical power.

14. The method of claim 12, each of the node devices comprises an electronic processor, a memory, and a communication interface configured to facilitate communication with one or more other node devices.

15. The method of claim 13, wherein the one or more network pool node devices include a local pool node device, a regional pool node device, and a national pool node device.

16. The method of claim 12, further comprising:
generating, at the local pool node device, a local energy market pool software agent comprising information associated with one or more market participant transaction requests within a service area of the local energy market pool node;
transmitting, by the local pool node device, the local energy market pool software agent to the regional pool node device; and
generating, at the regional pool node device, a regional market pool software agent comprising information associated with one or more local energy market pool software agents.

17. The method of claim 16, further comprising:
transmitting, by the regional pool node device the regional energy market pool software agent to the national pool node device;
determining a wholesale price for energy based on information provided by one or more regional energy market pool software agents; and
transmitting, by the national pool node device, the wholesale price to one or more of the regional node device and the local node device.

18. A system for performing energy transactions, the system comprising:
a plurality of market participant node devices, wherein each market participant node device is associated with an energy market participant and configured to generate one or more energy market participant software agents to facilitate an electrical power transaction;
a plurality of market authority node devices, wherein each market authority node device is associated with a market authority, wherein each market authority node device is associated with an energy market authority and configured to generate one or more energy market authority software agents to facilitate the electrical power transaction;
one or more network operator node devices, wherein each market authority node device is associated with a network operator, wherein each network operator node device is associated with a network operator and configured to generate one or more network operator software agents to facilitate the electrical power transaction;
wherein the market participant node devices, the market authority devices, and the network operator node devices are configured to communicate with each other to facilitate a proposed energy transaction; and
wherein the one or more market authority software agents are configured to determine the viability of the proposed energy transaction.

19. The system of claim 18, wherein the one or more market participant software agents include an energy buyer software agent, an energy seller software agent, and an infrastructure owner agent.

20. The system of claim 18, wherein the energy buyer software agent generates a request to buy electric power; and
wherein the energy seller software agent and the infrastructure owner agent process the generated request, wherein processing the generated request comprises determining a price based on one or more of power generation capacity, power prices, infrastructure capacity, and infrastructure costs.
